(19) United States
(12) Patent Application Publication
(10) Pub. No.: US 2016/0381554 A1
(43) Pub. Date: Dec. 29, 2016

(54) TERMINAL MANAGEMENT SYSTEM, MOBILE TERMINAL, AND STORAGE MEDIUM STORING TERMINAL MANAGEMENT PROGRAM

(71) Applicants: Kabushiki Kaisha Toshiba, Minato-ku (JP); Toshiba Solutions Corporation, Kawasaki-shi (JP)

(72) Inventors: Shingo ABE, Kawasaki (JP); Tatsuro IKEDA, Fuchu (JP); Tomoaki MORIJIRI, Chofu (JP)

(73) Assignees: Kabushiki Kaisha Toshiba, Minato-ku (JP); Toshiba Solutions Corporation, Kawasaki-shi (JP)

(21) Appl. No.: 15/259,487

(22) Filed: Sep. 8, 2016

Related U.S. Application Data
(63) Continuation of application No. PCT/JP2015/057010, filed on Mar. 10, 2015.

(30) Foreign Application Priority Data
Mar. 19, 2014 (JP) 2014-057221

(51) Int. Cl. H04W 12/06; H04W 4/00; H04M 1/67

(52) U.S. Cl. CPC H04W 12/06; H04M 1/67; H04W 4/008; H04W 84/20

(57) ABSTRACT

According to one embodiment, a setting delivery device includes an initial setting unit sets a setting card, a setting switching unit switch content of the setting card, and a setting deliver unit delivers the setting card to the mobile terminals. The mobile terminal includes a setting acceptance unit accepts the setting card, a policy creation unit for creating a policy when the setting card indicates setting of the master, a policy delivery unit for delivering the policy to a different mobile terminal, a policy acceptance unit accepts the policy delivered from an other mobile terminal, when the setting card indicates setting of the slave, and a terminal controller configured to restrict a function according to the policy accepted.

### CROSS REFERENCE TO RELATED APPLICATIONS

This application is a Continuation Application of PCT Application No. PCT/JP2015/057010, filed on Mar. 10, 2015, and is based upon and claiming the benefit of priority from Japanese Patent Application No. 2014-057221, filed Mar. 19, 2014, the entire contents of which are incorporated herein by reference.

### FIELD

The present invention relates to a terminal management system which manages mobile terminals, a mobile terminal in the system, and a storage medium which stores a terminal management program.

### BACKGROUND

At present, there have been an increasing number of companies in which mobile terminals, such as smartphones and tablet PCs, are provided to employees by the companies. Since a great amount of information, such as documents, contact information, and service login information, is stored in the mobile terminals, there is concern about security in the use in companies. For example, there is a possibility that an unlawful application is installed by the user, or the mobile terminal is unlawfully used by a third party due to a theft or loss.

Thus, in recent years, as a security measure of mobile terminals, a mobile device management (MDM) service has been gaining in popularity. By the mobile device management service, the mobile terminals existing in a company are managed in a centralized manner, and the security can be guaranteed (by executing a function restriction by a policy, the security setting of terminals, which prohibits users from doing unexpected actions, is performed in an integrated manner).

In general, in the management in a company, a plurality of groups are present, and restriction items are different among the groups. For example, there is a method in which, in a P2P (peer-to-peer) group, if a request for participation in the group was made, the participation in the group is permitted after confirming the authenticity of a communication counterpart by using an electronic certificate and a certificate revocation list.

However, in the conventional technology, a management terminal cannot be dynamically changed, and a request for participation in a group needs to be made to a fixed management terminal. If a failure occurs in the management terminal or if a case of disability of connection occurs due to a problem on a network, new participation in the group cannot be made. Moreover, if a policy, which is applied in the group, is to be changed, the setting cannot be changed unless the management terminal is usable, and such a situation occurs in which proper policy management cannot be realized.

### BRIEF DESCRIPTION OF THE DRAWINGS

FIG. 1 is a block diagram illustrating a schematic configuration of a terminal management system in the present embodiment.

FIG. 2 is a block diagram illustrating an example of a schematic hardware configuration of a setting delivery device in the embodiment.

FIG. 3 is a view illustrating an example of information included in a setting card which is used in the terminal management system of the embodiment.

FIG. 4 is a view which schematically illustrates a policy that is used in the terminal management system in the embodiment.

FIG. 5 is a block diagram illustrating a functional configuration of the terminal management system in the embodiment.

FIG. 6 is a view for describing the operation of the terminal management system (setting delivery device, mobile terminals) in the embodiment.

FIG. 7 is a view illustrating a functional configuration of the terminal management system including a mobile terminal which is set as a proxy master in the embodiment.

FIG. 8 is a view illustrating a plurality of mobile terminals included in two groups in the embodiment.

### DETAILED DESCRIPTION

In general, according to one embodiment, a terminal management system is a terminal management system which includes a plurality of mobile terminals, and a setting delivery device which is communicable with the mobile terminals. The setting delivery device includes an initial setting unit, a setting switching unit, and a setting deliver unit. The initial setting unit is configured to set a setting card for managing the mobile terminals and for executing setting at least as a master or a slave. The setting switching unit is configured to switch content of the setting card. The setting deliver unit is configured to deliver the setting card to the mobile terminals. The mobile terminal includes a setting acceptance unit, a policy creation unit, a policy delivery unit, a policy acceptance unit, and a terminal controller. The setting acceptance unit is configured to accept the setting card delivered by the setting delivery unit. The policy creation unit is configured to create a policy when the setting card accepted by the setting acceptance unit indicates setting of the master. The policy delivery unit is configured to deliver the policy created by the policy creation unit to a different mobile terminal. The policy acceptance unit is configured to accept the policy delivered from a policy delivery unit of an other mobile terminal, when the setting card accepted by the setting acceptance unit indicates setting of the slave. The terminal controller is configured to restrict a function according to the policy accepted by the policy acceptance unit.

An embodiment will be described hereinafter with reference to the accompanying drawings.

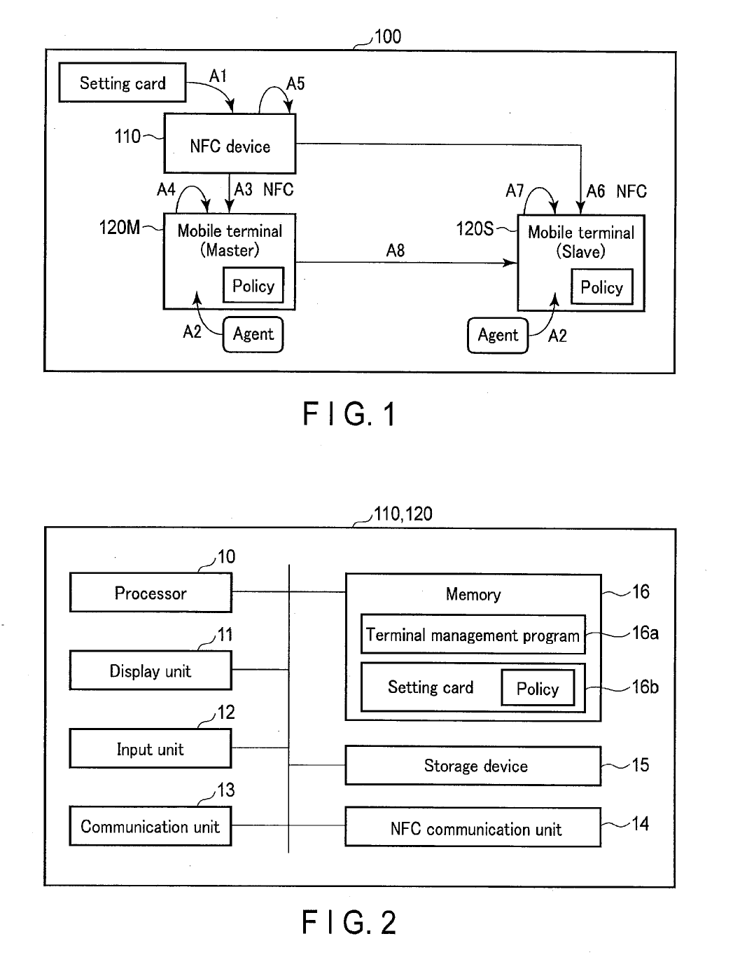

FIG. 1 is a block diagram illustrating a schematic configuration of a terminal management system in the present embodiment. As illustrated in FIG. 1, the terminal management system is composed of a setting delivery device 110 and a plurality of mobile terminals 120 (120M, 120S).

The setting delivery device 110 is a device for setting a configuration for policy management in the plural mobile terminals 120. The setting delivery device 110 is realized by, for example, a portable electronic device (NFC device) having an NFC (Near Field Communication) function (near-field wireless communication function), and is realized by, concretely, a smartphone or the like.

The mobile terminal 120 is, for example, a smartphone, a tablet PC, or some other portable electronic device, which is provided to an employee by a company. In the mobile terminal 120, a function restriction is executed by a policy, for example, in order to perform in an integrated manner the security setting of terminals, which prohibits users from doing unexpected actions.

By the setting by the setting delivery device 110, the mobile terminal 120 can be set as a master which operates as a management terminal that can deliver a policy to some other mobile terminal 120 and can cause the other mobile terminal 120 to set the policy, or can be set as a slave which receives a policy delivered from some other mobile terminal 120 that is set as a master, and which operates as a terminal in which this policy is set. Furthermore, the mobile terminal 120 can be set as a proxy master which receives a policy delivered from the mobile terminal 120 that is set as the master, and delivers the policy to some other mobile terminal 120.

FIG. 1 illustrates a schematic flow in which the mobile terminal 120 is set as a master or a slave by the setting delivery device (NFC device) 110.

To begin with, in the setting delivery device 110, the content of a setting card, which includes information for setting the mobile terminal 120, is initially set (A1). The setting card includes information for setting the mobile terminal 120 at least as a master or a slave (or a proxy master).

An agent (application) for controlling and managing operations is installed in the mobile terminal 120 (A2). The agent controls, for example, the mobile terminal 120 such that only the acceptance by NFC is enabled, and other functions are locked.

By an administrator moving the setting delivery device 110 into close proximity to the mobile terminal 120, the setting delivery device 110 delivers a setting card to the mobile terminal 120 by an NFC function.

For example, if a setting card including content, which sets the mobile terminal 120 as a master, is set, the setting delivery device 110 delivers the setting card which sets the mobile terminal 120 as the master (A3). The mobile terminal 120M, which received this setting card, dynamically determines the functional configuration so as to be capable of managing the policy as the master, according to the content that is set in the setting card (A4). Specifically, the mobile terminal 120M enables the function of creating a policy, and the function of delivering the policy to some other mobile terminal 120.

In addition, if a setting card including content, which sets the mobile terminal 120 as a slave, is set, the setting delivery device 110 delivers the setting card which sets the mobile terminal 120 as the slave (A6). The mobile terminal 120S, which received this setting card, dynamically determines the functional configuration such that the mobile terminal 120S is set as the slave in the state in which the mobile terminal 120S accepts the setting of the policy (A7). Specifically, the mobile terminal 120S enables the function of accepting the policy which is sent from the mobile terminal 120M that is set as the master, and the terminal control function of restricting the function according to the policy.

The mobile terminal 120M, 120S is configured to be capable of executing communication by wireless LAN (Local Area Network) such as Wi-Fi (trademark), or by short-range wireless communication such as Bluetooth (trademark). By delivering the policy to the mobile terminal 120S, the mobile terminal 120M manages the policy in the mobile terminal 120S.

The administrator can easily set the mobile terminal 120M or mobile terminal 120S, by switching the setting card of the setting delivery device 110 and moving the setting delivery device 110 into close proximity to the mobile terminal 120. Specifically, the administrator can dynamically set, by a simple work, the mobile terminal 120M among plural mobile terminals, which is set as the management terminal that manages the policy. Accordingly, even if a failure occurs in the mobile terminal 120M or if a state of disability of communication with the other mobile terminal 120 occurs due to a problem on the network, the management terminal which executes the policy setting can be flexibly changed, and proper policy management can be realized.

FIG. 2 is a block diagram illustrating an example of a schematic hardware configuration of the setting delivery device 110 in the embodiment.

As illustrated in FIG. 2, the setting delivery device 110 includes a processor 10, a display unit 11, an input unit 12, a communication unit 13, an NFC communication unit 14, a storage device 15, and a memory 16.

The processor 10 realizes various functions by executing programs stored in the memory 16. The processor 10 realizes the respective functions to be described below, by executing a terminal management program 16a for realizing the function of the setting delivery device, the terminal management program 16a being stored in the memory 16 (see FIG. 5).

The display unit 11, under the control of the processor 10, causes a display, such as an LCD (Liquid Crystal Display), to display various screens.

The input unit 12 is a unit for controlling an input corresponding to an operation by a user, and accepts an input from an input device such as a button, a key, or a touch panel.

The communication unit 13 is a communication unit which executes communication such as wireless LAN or short-range wireless communication, or mobile communication.

The NFC communication 14 is a communication unit which executes communication by NFC.

The storage device 15 is a device for storing programs and data in a nonvolatile storage medium.

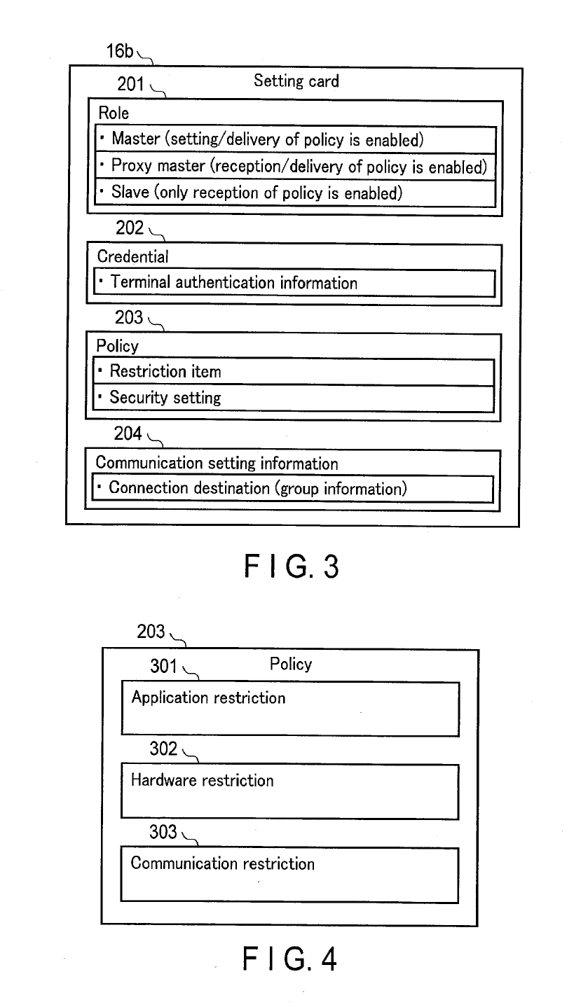

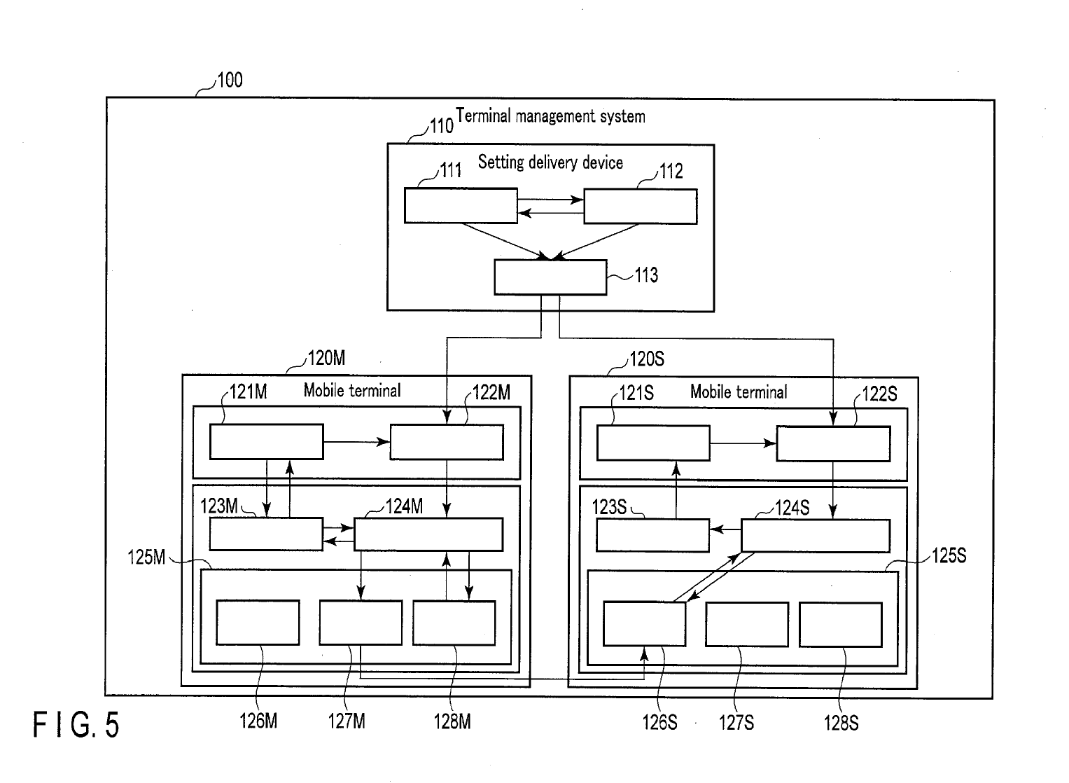

The memory 16 temporarily stores programs, which are executed by the processor 10, and data. The programs stored in the memory 16 include the terminal management program 16a for realizing the function as the setting delivery device 110. Data of a setting card 16b, which is associated with the execution of the terminal management program 16a, is included. Data relating to a policy is included in the setting card 16b (the details are illustrated in FIG. 3 and FIG. 4).

In the meantime, assuming that the mobile terminal 120 has the same functional configuration as in FIG. 2, a detailed description thereof is omitted. The processor 10 of the mobile terminal 120 realizes the respective functions to be described later by executing the terminal management program 16a (agent) for the mobile terminal (see FIG. 5). The mobile terminal 120 stores, in the memory 16, the setting card 16b which was received from the setting delivery device 110.

FIG. 3 is a view illustrating an example of information included in the setting card 16a which is used in the terminal management system of the present embodiment.

As illustrated in FIG. 3, it is assumed that at least a role 201 is included in the setting card 16b. In the present embodiment, as additional information, a credential 202, a basic policy 203 and communication setting information 204 are also included.

In the role 201, information determining the role of the mobile terminal 120 is described. The role 201 includes, for example, information for setting the mobile terminal 120 as the master (the role of enabling setting and delivery of the policy), information for setting the mobile terminal 120 as the proxy master (the role of enabling the reception and delivery of the policy), and information for setting the mobile terminal 120 as the slave (the role of enabling only the reception of the policy). Setting items, other than the items mentioned in the example of this embodiment, may be added.

The credential 202 is indicative of terminal authentication information for identifying the mobile terminal 120 that is the target of setting by the setting delivery device 110.

The policy 203 includes a restriction item which is set for the mobile terminal 120, and security setting. FIG. 4 is a view which schematically illustrates the policy 203 that is used in the terminal management system in the embodiment. The policy 203 of the embodiment includes, for example, an application restriction 301, a hardware restriction 302 and a communication restriction 303, and permission or prohibition is described with respect to each of them. In the meantime, aside of the simple description of permission or prohibition, some other arbitrary description method, such as a white list method or a black list method, may be used.

The communication setting information 204 includes group information representing a group that is a unit of policy management, the group information indicating, for example, a connection destination.

Next, a description is given of the outline of a functional configuration of the terminal management system which is realized by the terminal management program 16a.

FIG. 5 is a block diagram illustrating a functional configuration of the terminal management system 100 in the embodiment.

As illustrated in FIG. 5, the terminal management system 100 is composed of a setting delivery device 110 and a plurality of mobile terminals 120M, 120S. Although FIG. 5 illustrates only the mobile terminal 120M which is set as a master and the mobile terminal 120S which is set as a slave, it is assumed that, in one group which constitutes the terminal management system 100, two or more mobile terminals 120S that are set as slaves are included in the terminal management system 100. In addition, the mobile terminal 120M is not fixedly set for a specific device, but may be set for some other mobile terminal 120 by utilizing the setting delivery device 110. Moreover, in FIG. 5, although the mobile terminal 120M and the mobile terminal 120S are realized by difference devices, the function of the setting delivery device 110 may be realized in one mobile terminal 120.

As illustrated in FIG. 5, the setting delivery device 110 includes functions of an initial setting unit 111, a setting switching unit 112 and a setting delivery unit 113.

The initial setting unit 111 includes a function of setting a setting card which is delivered to the mobile terminal 120, and a function of saving the setting card. The setting switching unit 112 includes a function of switching the setting card which was set by the initial setting unit 111. The setting delivery unit 113 includes a function of delivering the setting card to the mobile terminal 120.

The mobile terminal 120 (120M, 120S) includes functions of a terminal controller 121, a setting acceptance unit 122, a policy management unit 123, a policy setting controller 124, a policy setting unit 125, a policy acceptance unit 126, a policy delivery unit 127, and a policy creation unit 128. In the meantime, in the mobile terminal 120M that is set as a master, illustration is made by a terminal controller 121M, a setting acceptance unit 122M, a policy management unit 123M, a policy setting controller 124M, a policy setting unit 125M, a policy acceptance unit 126M, a policy delivery unit 127M, and a policy creation unit 128M. In addition, in the mobile terminal 120S that is set as a slave, illustration is made by a terminal controller 121S, a setting acceptance unit 122S, a policy management unit 123S, a policy setting controller 124S, a policy setting unit 125S, a policy acceptance unit 126S, a policy delivery unit 127S, and a policy creation unit 128S.

The terminal controller 121 includes a function of executing a function restriction of the mobile terminal 120. The setting acceptance unit 122 includes a function of accepting a setting card which was sent from the setting delivery unit 113, and a function of sending the accepted card to the policy setting controller 124.

The policy management unit 123 includes a function of accepting the content of a policy, and a function of notification to the terminal controller 121.

The policy setting controller 124 includes a function of switching enabling/disabling of the policy acceptance unit 126, policy delivery unit 127 and policy creation unit 128 in the policy setting unit 125, in accordance with the content of the setting card which was received from the setting acceptance unit 122.

The policy setting unit 125 includes the policy acceptance unit 126, policy delivery unit 127 and policy creation unit 128. The policy acceptance unit 126 includes a function of accepting the policy which was delivered from some other mobile terminal 120. The policy delivery unit 127 includes a function of delivering the policy to some other mobile terminal 120. The policy creation unit 128 includes a function of editing the content of the policy.

Next, the operation of the terminal management system in the present embodiment is described.

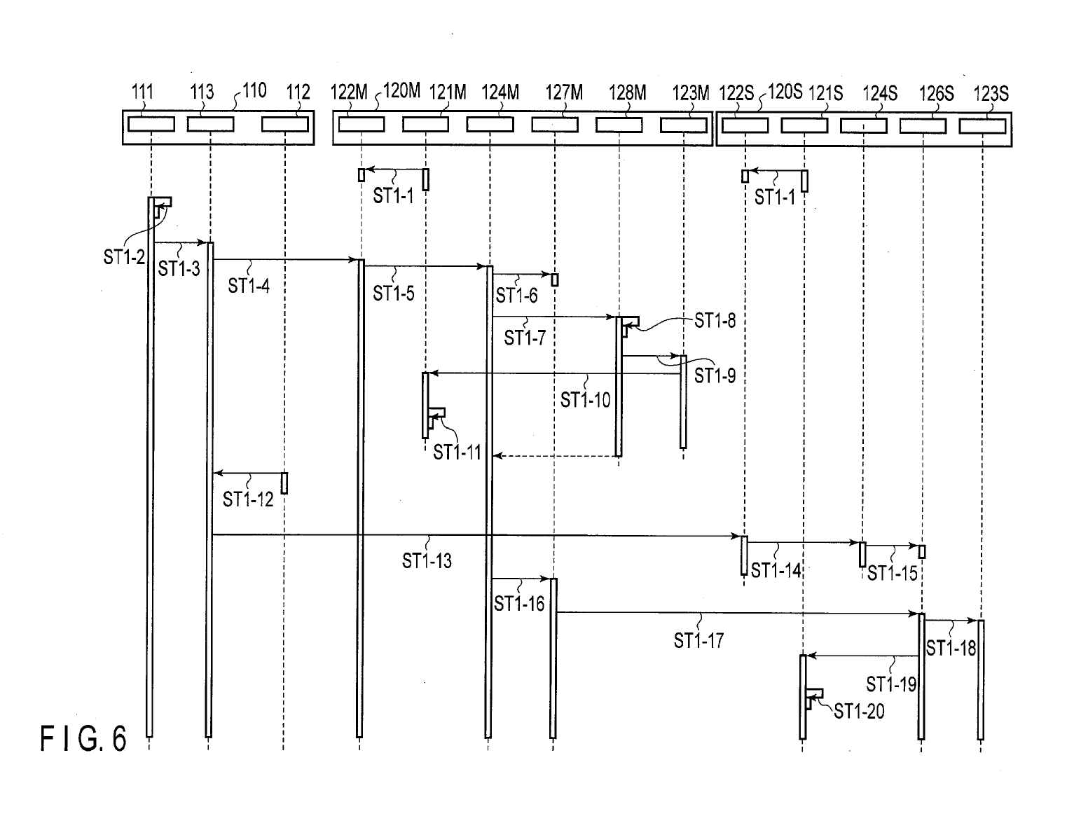

FIG. 6 is a view for describing the operation of the terminal management system (setting delivery device 100, mobile terminals 120M, 120S) in the embodiment.

To start with, the terminal controller 121M of the mobile terminal 120M executes a lock (function restriction) for the setting acceptance unit 122M, and enables the setting acceptance unit 122M (ST1-1). Similarly, the mobile terminal 120S executes a lock (function restriction) for the setting acceptance unit 122S, and enables the setting acceptance unit 122S (ST1-1).

The initial setting unit 111 of the setting delivery device 110 executes initial setting of the setting card 16b (ST1-2). The initial setting unit 111 reports the initially set setting card 16b to the setting delivery unit 113 (ST1-3). The setting delivery unit 113 delivers the setting card 16b to the setting acceptance unit 122 of the mobile terminal 120 (ST1-4).

The setting acceptance unit 122M of the mobile terminal 120M reports the content of the received setting card 16b to the policy setting controller 124M (ST1-5).

When the role 201 of the setting card 16b is the role of enabling the setting/delivery of the policy, the policy setting controller 124M enables the policy delivery unit 127M and policy creation unit 128M of the policy setting unit 125M in accordance with the role 201 described in the setting card 16b (ST1-6) (ST1-7). When the policy is to be edited, the edit of the policy is executed in the policy creation unit 128M (ST1-8).

The policy creation unit 128M reports the policy to the policy management unit 123M (ST1-9). The policy management unit 123M reports the control content of the mobile terminal 120M to the terminal controller 121 in accordance with the content of the policy (ST1-10).

The terminal controller 121 executes a function restriction of the mobile terminal 120M in accordance with the control content reported from the policy management unit 123M (ST1-11).

In this manner, by receiving the setting card 16b for the setting as the master from the setting delivery device 110, the mobile terminal 120M enables the policy acceptance unit 126M and policy creation unit 128M of the policy setting unit 125M, and is made to be capable of functioning as the management terminal of the policy.

On the other hand, when the setting of the mobile terminal 120S is executed, the setting switching unit 112 of the setting delivery device 110 switches the content of the setting card 16b to the content of slave setting, and reports the content to the setting delivery unit 113 (ST1-12). The setting delivery unit 113 delivers the setting card 16b to the setting acceptance unit 122 of the mobile terminal 120S (ST1-13).

The setting acceptance unit 122S of the mobile terminal 120S reports the content of the received setting card 16b to the policy setting controller 124 (ST1-14).

When the role 201 is the role of enabling only the reception of the policy, the policy setting controller 124S enables the policy acceptance unit 126 of the policy setting unit 125S in accordance with the role 201 described in the setting card 16b (ST1-15).

In this manner, by receiving the setting card 16b for the setting as the slave from the setting delivery device 110, the mobile terminal 120S enables the policy acceptance unit 126S of the policy setting unit 125M, and is made to be capable of accepting the policy which is delivered from the mobile terminal 120M.

The mobile terminal 120M, which was set as the master, delivers the policy to the other mobile terminal 120. The policy setting controller 124M of the mobile terminal 120M notifies the policy delivery unit 127 of the delivery of the policy to the mobile terminal 120S (ST1-16). In accordance with the notification of delivery from the policy setting controller 124M, the policy delivery unit 127M delivers the policy by short-range wireless communication or communication by wireless LAN (ST1-17).

The policy acceptance unit 126S of the mobile terminal 120S receives the policy which is delivered from the mobile terminal 120M, and reports the policy to the policy management unit 123 (ST1-18). The policy management unit 123S reports the control content of the mobile terminal 120S to the terminal controller 121S in accordance with the content of the policy (ST1-19). The terminal controller 121S executes a function restriction of the mobile terminal 120S in accordance with the reported control content (ST1-20).

In this manner, the mobile terminal 120S, which is set as the slave, accepts the policy which is delivered from the mobile terminal 120M, and can execute a function restriction by this policy. The mobile terminal 120M can be dynamically changed by the setting of the setting delivery device 110. Thus, even if a failure or the like occurs in the mobile terminal 120M, the policy, which is delivered from the changed mobile terminal 120M, can be similarly received in the same manner as before the change of the master, and the function restriction can be executed.

In the meantime, in FIG. 5, although only the mobile terminal 120M, which is set as the master, and the mobile terminal 120S, which is set as the slave, are illustrated, the mobile terminal 120 can be set as a proxy master by the setting delivery device 110.

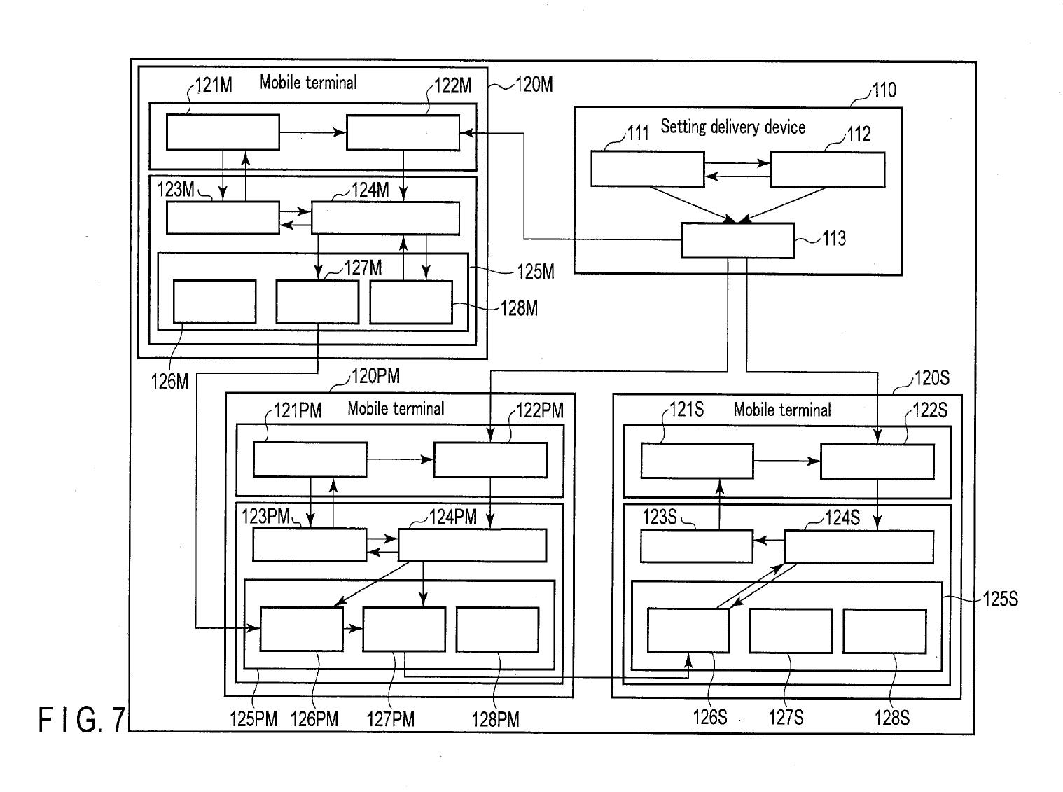

FIG. 7 is a view illustrating a functional configuration of the terminal management system including a mobile terminal 120PM which is set as a proxy master in the embodiment. Incidentally, in the mobile terminal 120PM which is set as a proxy master, illustration is made by a terminal controller 121PM, a setting acceptance unit 122PM, a policy management unit 123PM, a policy setting controller 124PM, a policy setting unit 125PM, a policy acceptance unit 126PM, a policy delivery unit 127PM, and a policy creation unit 128PM.

When the mobile terminal 120 is set as a proxy master, the setting delivery device 110 switches the role 201 of the setting card 16b to the content which enables reception/delivery of the policy, and delivers the content to the mobile terminal 120PM.

The setting acceptance unit 122PM of the mobile terminal 120PM accepts the setting card 16b from the setting delivery device 110, and reports the content of the setting card 16b to the policy setting controller 124PM. The policy setting controller 124PM enables the functions of the policy acceptance unit 126PM and policy delivery unit 127PM.

The mobile terminal 120PM, which was set as the proxy master, receives the setting card 16b which was delivered from the mobile terminal 120M, and is made to be capable of delivering this setting card 16b to some other mobile terminal 120S. The mobile terminal 120S can set the policy in the same manner as in the case of accepting the setting card 16b which was delivered from the mobile terminal 120M.

In this manner, by setting the mobile terminal 120PM as the proxy master, even if many mobile terminals 120S exist in one group, the setting card 16b can be delivered not only from the mobile terminal 120M but also from the mobile terminal 120PM, and efficient delivery/setting of the policy can be executed.

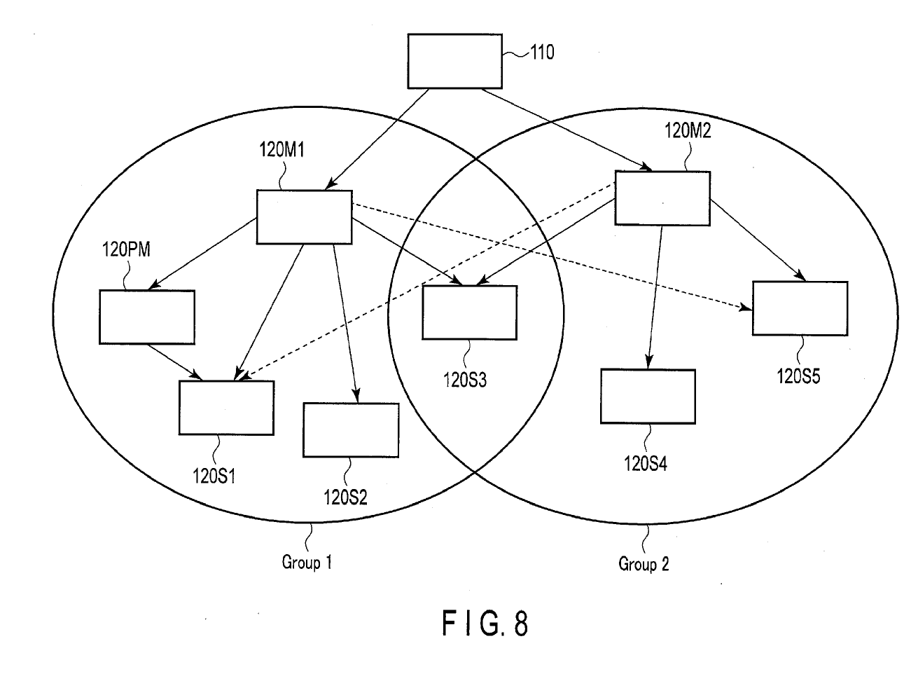

FIG. 8 is a view illustrating a plurality of mobile terminals 120 included in two groups 1 and 2 in the embodiment.

Although a description is omitted in the above, when the mobile terminal 120 received the setting card 16b from the setting delivery device 110 via NFC, the mobile terminal 120 executes an authentication process based on the credential 202 (terminal authentication information) which is included in the setting card 16b, and determines whether the mobile terminal 120 is a target of setting by the setting delivery device 110. Here, if the authentication fails, the above-described setting process based on the setting card 16b, which was received from the setting delivery device 110, is not executed.

In addition, the setting delivery device 110 can designate a connection destination (group information) by the description of the communication setting information 204 of the setting card 16b, and can set the mobile terminals 120, which are to be set as a master, a proxy master and a slave, on a group-by-group basis.

In FIG. 8, in a group 1, a mobile terminal 120M1 which is set as a mater, a mobile terminal 120PM which is set as a proxy master, and mobile terminals 120S1, 120S2 and 120S3, which are set as slaves, are illustrated. In addition, in a group 2, a mobile terminal 120M2 which is set as a mater, and mobile terminals 120S3, 120S4 and 120S5, which are set as slaves, are illustrated.

The mobile terminal 120M1 delivers a policy to the mobile terminals 120 included in the group 1. When the policy, which is delivered from the mobile terminal 120M1, is a policy for the group 1, the mobile terminals 120S1, 120S2 and 120S3 accept the policy, and execute the function restriction corresponding to the policy as described above. For example, it is assumed that even if the mobile terminal 120S1 receives a policy for the group 2, which was delivered from the mobile terminal 120M2, by short-range wireless communication or the like, the mobile terminal 120S1 does not accept this policy.

In addition, when the mobile terminal 120S1 received policies from, for example, the mobile terminal 120M1 that is the master and from the mobile terminal 120PM that is the proxy master, such a condition may be preset as executing a function restriction according to the policy which was received later, or executing a function restriction according to the policy which was received from the master, and the mobile terminal 120S1 may execute a process corresponding to this condition.

Similarly, the mobile terminal 120M2 delivers a policy to the mobile terminals 120 included in the group 2. When the policy, which is delivered from the mobile terminal 120M2, is a policy for the group 2, the mobile terminals 120S3, 120S4 and 120S5 accept the policy, and execute the function restriction corresponding to the policy as described above. For example, it is assumed that even if the mobile terminal 120S5 receives the policy for the group 1, which was delivered from the mobile terminal 120M1, by short-range wireless communication or the like, the mobile terminal 120S5 does not accept this policy.

In the meantime, the mobile terminal 120S3 shown in FIG. 8 is included in the groups 1 and 2. It is assumed that the setting delivery device 110 can set a slave which belongs to a plurality of groups, by the setting of the communication setting information 204 of the setting card 16b. In this case, the mobile terminal 120S3 can accept policies which are delivered from both the mobile terminal 120M1 of the group 1 and the mobile terminal 120M2 of the group 2. In this case, as regards the content having consistency with respect to the policies for the groups 1 and 2, the mobile terminal 120S3 sets the function restriction corresponding to the policies as such. As regards the content having no consistency with respect to the policies for the groups 1 and 2, such a condition may preset as giving priority to the content that prohibits a function, or executing a function restriction in accordance with the policy that was received later, and the mobile terminal 120S3 may execute function setting corresponding to this condition.

In the meantime, in the above description, it is assumed that when a fault occurred in the master, the master is set once again by using the setting delivery device 110. However, when the proxy master has detected abnormality of the master (for example, no communication or no response over a predetermined period or more), the proxy master may operate as the master.

In addition, when the communication between the setting delivery device 110 and the master is continued not by NFC, but by short-range wireless communication or wireless LAN, the setting delivery device 110 may monitor the operation state of the master. In this case, when the possibility of abnormality was detected by the monitoring by the setting delivery device 110 and the occurrence of abnormality was confirmed by the administrator, the master may be set by utilizing the setting delivery device 110 in the same manner as described above. Specifically, the setting delivery device 110 may be moved into close proximity to the mobile terminal that is to be set as the master, and the setting card may be transmitted by NFC, and thus the mobile terminal is set as the master.

In this manner, according to the present embodiment, by changing the content of the setting card 16b that is delivered from the setting delivery device 110, the management terminal (master) that executes policy setting can flexibly be changed. Even if such a case occurs that a fault occurred in the management terminal or that a connection was disabled due to a problem on the network, proper policy management can be executed, and a system with good security can be realized.

In the meantime, the method that has been described in connection with each of the above embodiments may be stored as a computer-executable program in a non-transitory computer-readable storage medium such as a magnetic disk (e.g. a flexible disk, a hard disk), an optical disk (e.g. a CD-ROM, a DVD), a magneto-optic disc (MO), or a semiconductor memory, and may be distributed.

Additionally, the storage form of this storage medium may be any form as long as the storage medium can store programs and is readable by a computer.

Additionally, an OS (operating system) running on a computer based on an instruction of a program installed from the storage medium into the computer, or MW (middleware), such as database management software or network software, may execute a part of each of processes for realizing the above embodiments.

Additionally, the storage medium in each embodiment is not limited to a medium which is independent from the computer, and includes a storage medium which stores or temporarily stores, by download, a program which is transmitted over a LAN or the Internet.

Additionally, the number of storage media is not limited to one. The configuration of the storage media in the invention includes such a case that the process in each of the above-described embodiments is executed from a plurality of media, and the configuration of the media may be any configuration.

Incidentally, the computer in each embodiment is a computer which executes each process in each embodiment, based on a program stored in the storage medium. The computer may have any configuration, for example, a configuration as a single apparatus such as a personal computer, or a configuration as a system in which a plurality of apparatuses are connected over a network.

Additionally, the computer in each embodiment is a general concept of equipment and apparatuses including an arithmetic processing apparatus included in information processing equipment, a microcomputer, etc., which can realize the functions of the invention by programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A terminal management system including a plurality of mobile terminals and a setting delivery device which is communicable with the mobile terminals,
the setting delivery device including:
an initial setting unit configured to set a setting card for managing the mobile terminals and for executing setting at least as a master or a slave;
a setting switching unit configured to switch content of the setting card; and
a setting deliver unit configured to deliver the setting card to the mobile terminals, and
the mobile terminal including:
a setting acceptance unit configured to accept the setting card delivered by the setting delivery unit;
a policy creation unit for creating a policy, when the setting card accepted by the setting acceptance unit indicates setting of the master;
a policy delivery unit for delivering the policy created by the policy creation unit to a different mobile terminal;
a policy acceptance unit configured to accept the policy delivered from a policy delivery unit of an other mobile terminal, when the setting card accepted by the setting acceptance unit indicates setting of the slave; and
a terminal controller configured to restrict a function according to the policy accepted by the policy acceptance unit.

2. The terminal management system of claim 1, wherein the setting delivery device is configured to deliver, by the setting delivery unit, a setting card for setting as a proxy master to the mobile terminal, and
the mobile terminal is configured to deliver, by the policy delivery unit, a policy, which was delivered from an other mobile terminal and accepted by the policy acceptance unit, to a different mobile terminal, when the setting card accepted by the setting acceptance unit indicates setting of the proxy master.

3. The terminal management system of claim 1, wherein the setting delivery device and the mobile terminal communicate by near-field wireless communication.

4. A mobile terminal including:
a setting acceptance unit configured to accept a setting card for setting at least as a master or a slave, the setting card being delivered by a setting delivery device;
a policy creation unit for creating a policy, when the setting card accepted by the setting acceptance unit indicates setting of the master;
a policy delivery unit for delivering the policy created by the policy creation unit to a different mobile terminal;
a policy acceptance unit configured to accept the policy delivered from a policy delivery unit of an other mobile terminal, when the setting card accepted by the setting acceptance unit indicates setting of the slave; and
a terminal controller configured to restrict a function according to the policy accepted by the policy acceptance unit.

5. A non-transitory computer-readable storage medium having stored thereon a terminal management program which is executable by a computer, the program controlling the computer to function as:
a setting acceptance unit configured to accept a setting card for setting at least as a master or a slave, the setting card being delivered by a setting delivery device;
a policy creation unit for creating a policy, when the setting card accepted by the setting acceptance unit indicates setting of the master;
a policy delivery unit for delivering the policy created by the policy creation unit to a different mobile terminal;
a policy acceptance unit configured to accept the policy delivered from a policy delivery unit of an other mobile terminal, when the setting card accepted by the setting acceptance unit indicates setting of the slave; and
a terminal controller configured to restrict a function according to the policy accepted by the policy acceptance unit.
